(19) United States
(12) Patent Application Publication
(10) Pub. No.: US 2006/0237314 A1
(43) Pub. Date: Oct. 26, 2006

(54) Solid-electrolyte sensing elements provided with a hollow element for thermal expansion

(76) Inventors: Thomas Wahl, Pforzheim (DE); Thomas Egner, Anderson, SC (US); Lothar Diehl, Gerlingen (DE); Stefan Rodewald, Ditzingen (DE); Frank Buchholz, Neckartenzlingen (DE)

Correspondence Address: KENYON & KENYON LLP, ONE BROADWAY, NEW YORK, NY, 10004, US

(21) Appl. No.: 10/544,532

(22) PCT Filed: Nov. 5, 2003
(86) PCT No.: PCT/DE03/03659

§ 371 Date: May 31, 2006

(30) Foreign Application Priority Data
Feb. 11, 2003 (DE) 10305533.9

(51) Int. Cl. G01N 27/26

(52) U.S. Cl. 204/424

(57) ABSTRACT

A sensor element having a layer-type construction is used to determine a physical quantity of a measurement gas, in particular to determine the concentration of a gas component of the measurement gas. The sensor element includes at least one heater and at least one measurement element. The heater is surrounded by a heater insulation. Between the heater and the heater insulation there is provided, at least in some areas, a hollow element.

### FIELD OF THE INVENTION

The present invention relates to a sensor element.

### BACKGROUND INFORMATION

A sensor element is described for example, in German Patent Application Serial No. DE 100 53 107 A1. The sensor element is constructed in layer form with planar technology, and contains, for the heating of a measurement element, a heating element that is situated between two solid electrolyte layers. The heating element includes a heater and a heater insulation. The heater is completely embedded in the heater insulation, and is electrically insulated from the surrounding solid electrolyte layers by the heater insulation.

The solid electrolyte layers are made of zirconium oxide stabilized with yttrium oxide. The heater insulation is made of aluminum oxide. The heater is made of platinum.

The sensor element is manufactured by applying functional layers, such as the heater insulation and heater, onto a solid electrolyte film (foil) (solid electrolyte layer before sintering) using screen printing. The printed solid electrolyte films are subsequently laminated together and sintered.

At the end of the sintering process, a tension-free state has at first formed between the layers (solid electrolyte layer, heater insulation and heater). After the subsequent cooling of the sensor element, the heater insulation is exposed to tensile stress, because the thermal expansion coefficient of aluminum oxide is less than the thermal expansion coefficient of zirconium oxide and platinum.

If the sensor element is now set into operation and is heated to the required operating temperature by the heater, the heater insulation is stressed, because in the area of the heater there occur high temperature gradients, and thus additional stresses. Because the expansion coefficient of the heater (platinum) is greater than is the expansion coefficient of the heater insulation, the heater insulation is also exposed to additional stresses due to the volume expansion of the heater. This can result in the formation of cracks in the heater insulation, causing the heater to split.

German Patent No. DE 43 43 089 describes a heating element in which a hollow space is provided between the heater insulation and the solid electrolyte layer. In this system, it is disadvantageous that the heater insulation is additionally exposed to stresses, and that the heat conduction from the heater into the measurement element is worsened.

### SUMMARY

An example sensor element according to the present invention may have the advantage that when the sensor element is heated to the operating temperature a volume is available into which the heater can expand without thereby exposing the heater insulation to additional stresses. For this purpose, a hollow element is provided between the heater and the heater insulation, in which the heater can expand due to its plastic deformability, which is good at operating temperatures.

If a crack forms in the heater insulation, causing a displacement of the printed conductor forming the heater in a direction perpendicular to the layer plane of the heater, an alternate volume is available for the heater, and the splitting of the heater printed conductor by shearing is avoided.

Advantageously, in one embodiment the hollow element is formed as a hollow space. In an alternative specific embodiment of the present invention, the hollow element is a highly porous layer having a pore proportion of at least 30 percent by volume. A splitting of the heater is avoided in a particularly reliable manner if the highly porous layer of the hollow element has a pore proportion of at least 50 percent by volume.

If the hollow element is situated on the side of the heater facing away from the measurement element, then in addition a good propagation of heat from the heater to the measurement element is guaranteed, while the propagation of heat into the side of the sensor element facing away from the measurement element is lessened by the hollow element. This situation of the hollow element has a particularly advantageous effect in sensor elements in which the heater is situated in a large surface whose distance to the outer surface of the sensor element in the direction of the measurement element is greater than the distance to the outer surface, situated opposite, of the sensor element. Despite the asymmetrical situation of the heater, a largely symmetrical heat distribution is achieved in the sensor element due to the stronger flow of heat in the direction of the measurement element.

The expansion of the heater in a direction perpendicular to the large surface of the sensor element and perpendicular to its longitudinal extension is advantageously smaller than is the expansion of the hollow element in this direction. In this way, the heater can also expand in the large surface of the sensor element.

The hollow element is formed as a continuous layer. Alternatively, the hollow element is subdivided into a multiplicity of channels that extend in the large surface of the heater perpendicular to the longitudinal extension of the heater. Due to the channels, the movement of ions along the longitudinal extension of the heater is avoided, or is at least limited.

The heater is connected electrically with two heater supply lines. The heater supply lines extend along the longitudinal axis of the sensor element and are connected, by through-connections and contact surfaces, with circuitry situated outside the sensor element, through which a heating voltage is applied between the heater supply lines. The heater supply lines advantageously have a greater layer thickness than does the heater. The layer thickness of the heater supply line is approximately twice as large as the layer thickness of the heater, and corresponds approximately to the sum of the layer thicknesses of the heater and the hollow element. The greater layer thickness advantageously reduces the resistance of the heater supply line.

### BRIEF DESCRIPTION OF THE DRAWINGS

An exemplary embodiment of the present invention is shown in the drawing and is explained in more detail in the subsequent description.

FIG. 1 shows, as an exemplary embodiment of the present invention, a cross-section through a sensor element.

FIGS. 2a to 2d show four specific embodiments of the construction according to the present invention of the heater, heater insulation, and hollow element.

FIGS. 3 and 4 show a longitudinal section through two additional specific embodiments of the sensor element.

### DETAILED DESCRIPTION OF EXAMPLE EMBODIMENTS

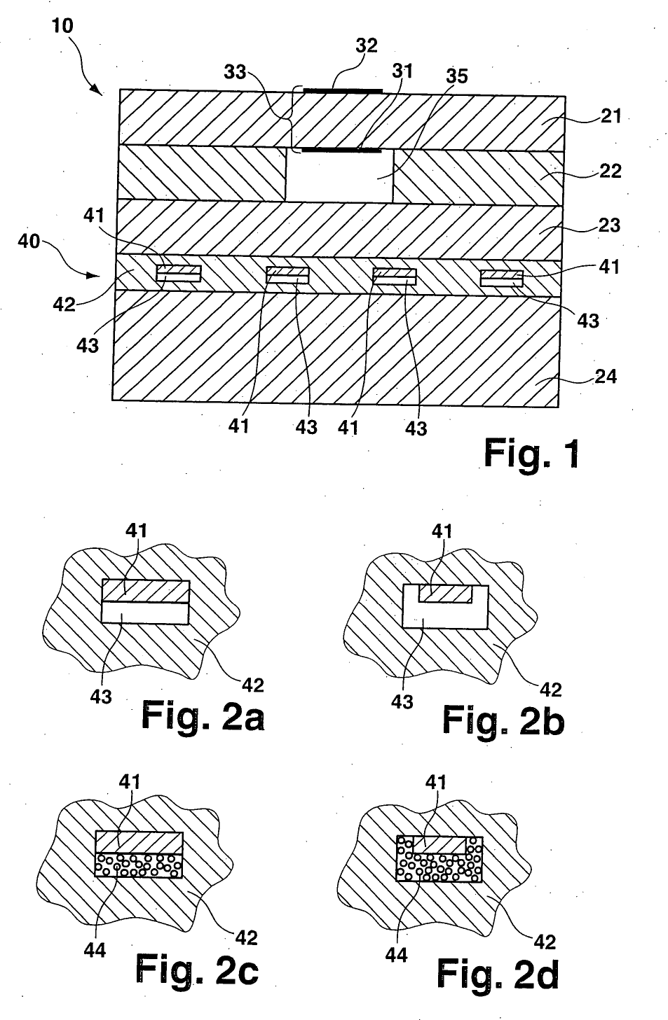

FIG. 1 shows, as an exemplary embodiment of the present invention, a sensor element 10 having a first, a second, a third, and a fourth solid electrolyte layer 21, 22, 23, 24. A reference gas compartment 35, containing a reference gas having a high concentration of oxygen, is built into second solid electrolyte layer 22. A first electrode 31 is applied onto first solid electrolyte layer 21 in reference gas compartment 35. On the side situated opposite first electrode 31, a second electrode 32 is situated on the outer surface of first solid electrolyte layer 21. Together with solid electrolyte 21 situated between the two electrodes 31, 32, first and second electrodes 31, 32 form an electrochemical cell, thus forming measurement element 33 of sensor element 10.

Third solid electrolyte layer 23 is adjacent to second solid electrolyte layer 22. A heating element 40 is provided between third and fourth solid electrolyte layers 23, 24. Heating element 40 includes a heater 41 having a meander-shaped printed conductor that is embedded in a heater insulation 42 and that is electrically insulated from the surrounding solid electrolyte layers 23, 24 by heater insulation 42. On the side of heater 41 facing away from measurement element 33, there is provided a hollow element formed as a hollow space 43. The width of heater 41 and the width of hollow space 43 (i.e., the extension in the large surface of sensor element 10 perpendicular to the longitudinal extension of the heater) are equal.

The thickness of fourth solid electrolyte layer 24 (i.e., the extension of fourth solid electrolyte layer 24 perpendicular to the large surface of sensor element 10) is approximately 60% of the distance of heater 41 from the outer surface of sensor element 10, on which second electrode 32 is situated (i.e., generally the sum of the thicknesses of first, second, and third solid electrolyte films 21, 22, 23). Despite the asymmetrical situation of heater 41, in sensor element 10 there forms a largely symmetrical distribution of heat, because the heat distribution into fourth solid electrolyte layer 24 is limited by hollow space 43.

FIGS. 2a, 2b, 2c, and 2d show, in various specific embodiments, heater 41, heater insulation 42, and hollow element 43, 44. Corresponding elements are identified here and in the Figures with identical reference characters. The specific embodiment shown in FIG. 2a corresponds to the exemplary embodiment in FIG. 1. In the specific embodiment shown in FIG. 2b, the width of heater 41 is less than is the width of the hollow element formed as hollow space 43, so that heater 41 can expand both in the layer plane of heater 41 and also perpendicular thereto. The specific embodiments shown in FIGS. 2c and 2d correspond to the specific embodiments shown in FIGS. 2a and 2b, the hollow element being formed as a porous material 44 having, in the present specific embodiments, a pore proportion in the range from 30 to 40 percent by volume, in particular 35 percent by volume.

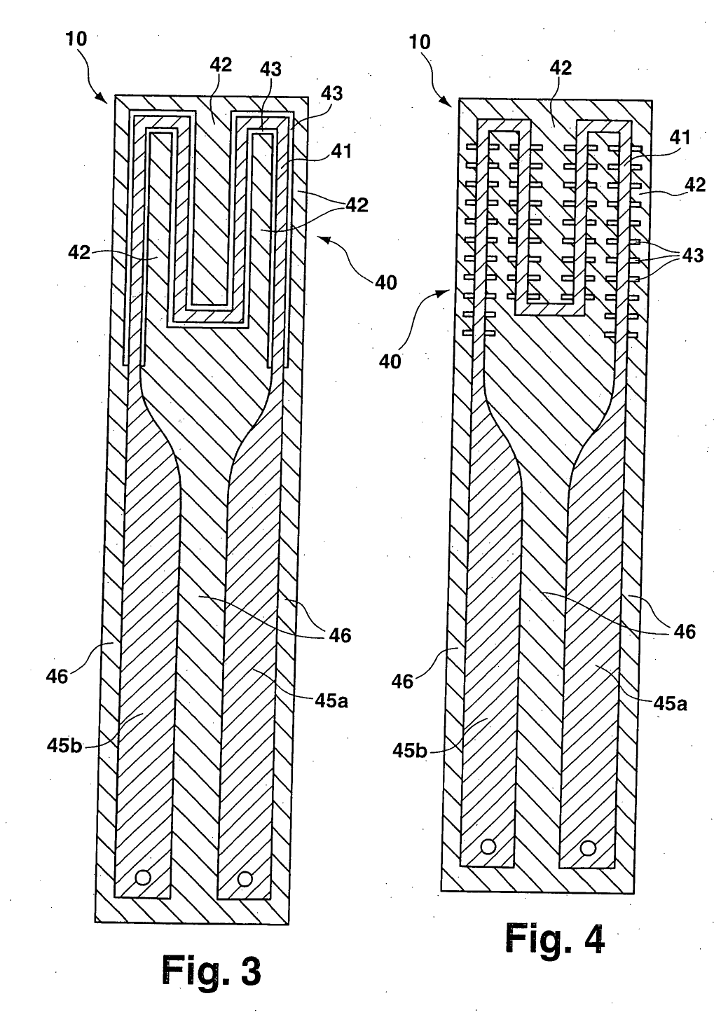

FIG. 3 shows a sectional representation of a specific embodiment of sensor element 10 according to the present invention, the section being made along the layer plane of heater 41. The design of heater 41, heater insulation 42, and hollow space 43 correspond to the specific embodiment in FIG. 2b. Heater 41 is connected electrically with a first and with a second heater supply line 45a, 45b, which extend along the longitudinal axis of sensor element 10. Through a circuit arrangement situated outside the gas sensor, a heating voltage is applied between heater supply lines 45a, 45b, and measurement element 33 of sensor element 10 is heated by the current flowing through heater 41. Heater supply lines 45a, 45b are completely surrounded by a heater supply line insulation 46. Heater supply line insulation 46 abuts heater supply lines 45a, 45b directly. The height of heater supply line 45a, 45b (i.e., the extension perpendicular to the section plane of FIG. 3) is twice as large as the height of heater 41. The sum of the heights of heater 41 and hollow space 43 corresponds approximately to the height of heater supply lines 45a, 45b. The situation of heater 41 inside hollow space 43 corresponds to the construction shown in FIG. 2b.

In an alternative specific embodiment (not shown) of the present invention, the height of the heater supply line corresponds approximately to the height of the heater. In this specific embodiment, an advantageous savings of material results.

FIG. 4 shows a further specific embodiment in the sectional representation already selected in FIG. 3. The specific embodiment shown in FIG. 4 differs from the specific embodiment shown in FIG. 3 in that the hollow element, formed as hollow space 43, is subdivided into a multiplicity of channels that extend perpendicular to the longitudinal extension of heater 41 in the large surface of sensor element 10.

1-13. (canceled)

14. A sensor element having a layer-type construction, for determining a concentration of a gas component of a measurement gas, comprising:
at least one heater;
at least one measuring element;
a heater insulation, the heater being surrounded by the heater insulation;
wherein a hollow element is provided at least in some areas between the heater and the heater insulation.

15. The sensor element as recited in claim 14, wherein the hollow element is a hollow space.

16. The sensor element as recited in claim 14, wherein the hollow element is a porous material having open porosity and having a pore proportion of 15 to 70 percent by volume.

17. The sensor element as recited in claim 16, wherein the porous material has a pore proportion of 30 to 40 percent by volume.

18. The sensor element as recited in claim 14, wherein the hollow element is provided on a side of the heater facing away from the measurement element.

19. The sensor element as recited in claim 14, wherein an expansion of the heater in a direction perpendicular to a large surface of the sensor element and perpendicular to a longitudinal extension of the heater is less than or equal to an expansion of the hollow element in this direction.

20. The sensor element as recited in claim 19, wherein the expansion of the heater in a direction perpendicular to the large surface of the sensor element and perpendicular to the longitudinal extension of the heater is at most half the expansion of the hollow element in this direction.

21. The sensor element as recited in claim 14, wherein the hollow element is subdivided into a plurality of channels that extend in a large surface of the heater perpendicular to a longitudinal extension of the heater.

22. The sensor element as recited in claim 14, wherein the measurement element includes at least one electrochemical cell, the electrochemical cell containing a first electrode, a second electrode, and a solid electrolyte situated between the first electrode and the second electrode.

23. The sensor element as recited in claim 22, further comprising:
a reference gas compartment in which the first electrode is situated, the reference gas compartment being built into the sensor element, and the reference gas compartment one of directly abutting the heater insulation, or separated from the heater insulation by a solid electrolyte film.

24. The sensor element as recited in claim 14, wherein the heater insulation abuts a solid electrolyte layer of the sensor element.

25. The sensor element as recited in claim 14, wherein the heater is connected electrically with a first heater supply line and with a second heater supply line.

26. The sensor element as recited in claim 25, wherein an expansion of the heater perpendicular to a large surface of the sensor element is less than an expansion of the heater supply lines in this direction.

27. The sensor element as recited in claim 25, wherein the first and second heater supply line are surrounded by a heater supply line that abuts the first and second heater supply line directly.
